(19) United States
(12) Patent Application Publication
(10) Pub. No.: US 2026/0050643 A1
(43) Pub. Date: Feb. 19, 2026

(54) Method and System for Generating Knowledge Management and Discovery Topic Maps

(71) Applicant: STATE FARM MUTUAL AUTOMOBILE INSURANCE COMPANY, Bloomington, IL (US)

(72) Inventors: Sophie Hazel Rodgers, Chicago, IL (US); Daniel Holley, Champaign, IL (US); Timothy Krashevsky, Champaign, IL (US); Yunqi Tian, Normal, IL (US); Donald Cox, Bloomington, IL (US); Jason Smith, Flower Mound, TX (US)

(21) Appl. No.: 16/817,853

(22) Filed: Mar. 13, 2020

(51) Int. Cl. G06F 16/9538; G06F 9/54; G06F 16/23; G06F 16/2457; G06Q 10/10; H04L 67/01; H04L 67/1095

(52) U.S. Cl. CPC G06F 16/9538; G06F 9/547; G06F 16/2343; G06F 16/2379; G06F 16/24578; H04L 67/025; H04L 67/1095; G06Q 10/10

(57) ABSTRACT

A method for generating topic maps includes receiving user data via an editor, transmitting the data to a remote device, synchronizing an access, monitoring a remote topic, updating a local topic, and causing the editor to display the local topic. A computing system includes one or more processors and a memory including computer executable instructions that, when executed by the one or more processors, cause the computing system to receive data via an editor, transmit the data to a remote device, synchronize an access, monitor a remote topic, update a local topic, and cause the editor to display the local topic. A non-transitory computer readable medium containing program instructions that when executed, cause a computer system to receive data via an editor, transmit the data to a remote device, synchronize an access, monitor a remote topic, update a local topic, and cause the editor to display the local topic.

### FIELD OF THE DISCLOSURE

The present disclosure generally relates to a system and method of generating knowledge management and discovery topic maps, and more particularly to methods and systems for implementing visual applications for defining and representing topical information organization and structures.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Knowledge management (KM) is the study of creating, sharing, using and managing knowledge and information within an organization. KM may be practiced full-time or part-time by members of an organization. For example, a large corporation may certify one or more manager (e.g., a project manager) as a certified knowledge manager (CKM) who acts as a full-time liaison between different teams. In other cases, KM may be a set of skills practiced by members of an organization that generates and uses large amounts of digital information in a structured fashion. For example, the United States Army has promulgated KM standards for the creation, organization, application and transfer of knowledge to be followed by all personnel.

In a networked information domain that includes individual, organizational, and public spaces, organizing and finding information efficiently is difficult. The criteria of a high quality enterprise content management (ECM) system include accuracy, accessibility, and relevance. However, conventional ECM methods and systems are lacking and do not achieve such goals for several reasons. First, information creation applications present information but do not catalog information effectively. Second, ECM information search focuses on keyword matching and does not handle synonyms or homonyms. For example, existing search technologies (e.g., Microsoft FAST, Google, Bing, etc.) are keyword-based and use proprietary ranking algorithms for linearly displaying search results. Curated directories may meaningfully organize content hierarchically, but they are not a useful tool for organizing large volumes of networked information. Existing systems may allow users to add information easily, but make information retrieval and searching very difficult. The World Wide Web Consortium (W3C) has proposed Semantic Web technology, using the building blocks of extensible Markup Language (XML), Resource Description Framework (RDF) and Web Ontology Language (OWL) that allow some unstructured web data to be represented as structured data. However, Semantic Web technologies require the content to be rewritten to integrate search support. Further, when there is a lack of Semantic Web content, search engine providers will not upgrade their technologies to incorporate the content and even when there is popular search support, Semantic Web technologies do not effectively organize and retrieve networked data. Third, conventional ECM search result display is a linear list of documents with a one-size-fit-all ranking method.

For example, bookmarks are a conventional means of organizing web pages that use a rigid structure (e.g., a list). Conventional bookmarking methods and systems do not allow a user to easily rearrange, edit or update the bookmarks. Further, once the number of bookmarks grows to a large number (e.g., one hundred or more), a user will struggle to find a bookmark within the list. The drawbacks inherent to conventional bookmarking systems are a problem for organizations as well as for individual users. Fourth, content repositories that are organized into vertical siloes, are common and do not meet the quality criteria. Fifth, conventional ECM user interfaces are difficult to use and require repetitive actions, causing frustration and lost worker productivity. Sixth, within an organization, subject matter experts (SMEs) may have a long history of working at the organization and may have learned a lot of information. However the information is not accessible to other, more junior employees. The junior employees may not know which SMEs to talk to, to learn the necessary information. Currently, there is a mismatch between the objectives of KM and the capabilities of ECM. What is needed are tools that allow KM best practices to be achieved in networked information domains.

### BRIEF SUMMARY

In one aspect, a computer implemented method for generating and displaying a knowledge management and discovery topic map includes receiving, via a processor, input data from a user via a rich internet application topic map editor, wherein the topic map includes at least one topic and at least one occurrence, transmitting, via a computer network, the input data from the user corresponding to the topic map to a remote computing device, the input data including one or more map identifiers corresponding to the at least one topic and the at least one occurrence, synchronizing an access of the first user to the one or more map identifiers with an access of a second user, monitoring at least one remote topic associated with the one or more map identifiers, updating, when the remote topic changes, a local topic associated with the at least one remote topic; and causing the topic map editor to display the rich internet application topic map editor including the local topic.

In another aspect, a knowledge management and discovery topic map computing system includes one or more processors and a memory including computer executable instructions. The computer executable instructions, when executed by the one or more processors, cause the computing system to receive, via a processor, input data from a user via a rich internet application topic map editor, wherein the topic map includes at least one topic and at least one occurrence, transmit, via a computer network, the input data from the user corresponding to the topic map to a remote computing device, the input data including one or more map identifiers corresponding to the at least one topic and the at least one occurrence, synchronize an access of the first user to the one or more map identifiers with an access of a second user, monitor at least one remote topic associated with the one or more map identifiers, update, when the remote topic changes, a local topic associated with the at least one remote topic; and cause the topic map editor to display the rich internet application topic map editor including the local topic.

In yet another aspect a non-transitory computer readable medium containing program instructions that when executed, cause a computer system to receive, via a processor, input data from a user via a rich internet application topic map editor, wherein the topic map includes at least one topic and at least one occurrence, transmit, via a computer network, the input data from the user corresponding to the topic map to a remote computing device, the input data including one or more map identifiers corresponding to the at least one topic and the at least one occurrence, synchronize an access of the first user to the one or more map identifiers with an access of a second user, monitor at least one remote topic associated with the one or more map identifiers, update, when the remote topic changes, a local topic associated with the at least one remote topic; and cause the topic map editor to display the rich internet application topic map editor including the local topic.

### BRIEF DESCRIPTION OF THE DRAWINGS

FIG. 1 depicts an example computing environment for implementing knowledge management and discovery topic maps, according to an embodiment.

FIG. 2 depicts an example knowledge management and discovery topic map, according to an embodiment.

FIG. 3 depicts a listing of exemplary edge types that may be used to represent relationships between entities represented by topic nodes, according to an embodiment.

FIG. 4A depicts an example topic map visual application in an editing mode, according to an embodiment.

FIG. 4B depicts an example visual application in a viewing mode, according to an embodiment.

FIG. 5 depicts a block diagram of an example method for generating and displaying knowledge management and discovery topic maps, according to one embodiment and scenario.

FIG. 6 depicts a block diagram of an exemplary method 600 for generating and displaying knowledge management and discovery topic maps, according to one embodiment.

### DETAILED DESCRIPTION

### Overview

The present techniques include methods and systems for implementing enterprise content management, and more particularly, methods and systems for implementing topic maps in a visual application for representing networked information, to achieve knowledge management objectives. In particular, methods and systems implementing visual applications that include topic maps for representing the topical structure of information, and for defining relationships between such topical structures, are disclosed. One solution provided by the present techniques for overcoming problems in the networked information management and search domain is the creation of a crowd-sourced platform that allows a registered user to create and edit visual topic maps and to use concept search instead of keyword search to present the topic maps that matches the search query. In some embodiments, topic maps may be implemented using an abstract model and grammar such as XML Topic Maps (XTM), Concept Mapping Extensible Language (CXL), etc.

### Example Computing Environment

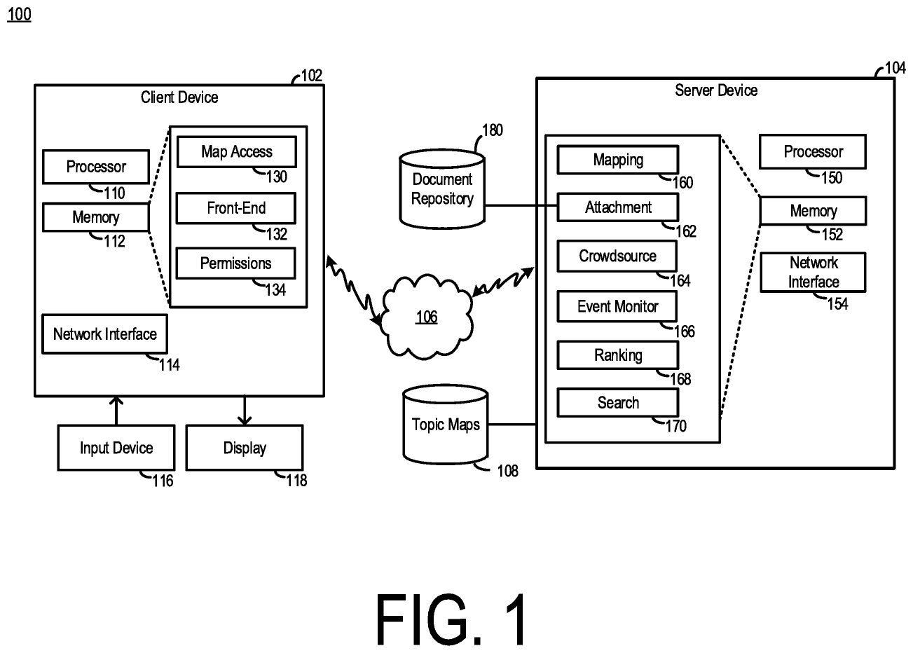

FIG. 1 depicts an example computing environment 100 for implementing methods and systems for generating knowledge management and discovery topic maps. The environment 100 may include a client device 102, a topic map server device 104, a network 106, and a topic maps database 108. Generally, the client device 102 permits user access to the topic map server device 104 for the purpose of creating, retrieving, editing and deleting topic maps and topic map components. The client device 102 may be any suitable device (e.g., a smart phone, a wearable device, a laptop device, a desktop computer, etc.). Topic maps may be stored in the maps database 108. In general, a topic map includes three elements: 1) at least one topic, 2) at least one association, and 3) at least one occurrence.

The client device 102, the topic map server device 104, and the topic maps database 108 are communicatively coupled via the network 106. In some embodiments, the client device 102 may be remote from the topic map server device 104. The network 106 may include any suitable combination of wired and/or wireless communication networks, such as one or more local area networks (LANs), metropolitan area networks (MANs), and/or wide area network (WANs). As just one specific example, the network 106 may include a cellular network, the Internet, and a server-side LAN. As another example, the network 106 may support a cellular (e.g., 4G, 5G, etc.) connection to a mobile computing device of a user and an IEEE 802.11 connection to the mobile computing device. The topic maps database 108 may comprise any suitable database (e.g., a structured query language (SQL) database, a flat file database, a key/value data store, a relational database management system (RDBMS), etc.), a plurality of database tables for storing data according to data storage schema, relational linkages between tables, and complex data types such as time series data. The server 104 may, in some implementations, include multiple servers and/or other computing devices. Moreover, the server 104 may include multiple servers and/or other computing devices distributed over a large geographic area (e.g., including devices at one or more data centers), and any of the operations, computations, etc., described below may be performed in by remote computing devices in a distributed manner.

The client device may include a processor 110, a memory 112, a network interface 114, an input device 116 and a display 118. The processor 110 may be a single processor (e.g., a central processing unit (CPU)), or may include a set of processors (e.g., a CPU and a graphics processing unit (GPU)). The computing environment 100 may include one or more instances of the client device 102. For example, a first user may use a first client device 102 while a second user uses a second client device 102 and so on with many (e.g., thousands) of users distributed throughout an organization. The many users may be geographically distributed throughout a large area (e.g., throughout the world). In some cases, a first instance of the client device 102 may be configured as a server or a desktop-configured instance, whereas a second instance is configured as a mobile computing device instance. The one or more instances of the client device 102 may access the topic map server device 104 to simultaneously access one or more topic maps stored in a memory of the server device and/or the topic maps database 108.

The memory 112 may be a computer-readable, non-transitory storage unit or device, or collection of units/devices, that includes persistent (e.g., hard disk) and/or non-persistent memory components. The memory 112 may store instructions that are executable on the processor 110 to perform various operations, including the instructions of various software applications and data generated and/or used by such applications. For example, the memory 112 may include one or more memory modules, such as a map access module 130, a front-end module 132, and a permission module 134. In the example implementation of FIG. 1, the memory 112 stores instructions that when executed by the processor 120 facilitate the collection and transmission of user input such as selections and inputs corresponding to a topic map front-end program included in the front-end module 132.

The network interface 114 includes hardware, firmware and/or software configured to enable the client device 102 to exchange electronic data with other devices on the network 106 (e.g., the server 104), and to access other networked resources, such as the topic maps database 108. For example, network interface 114 may include a cellular communication transceiver, a Wifi transceiver, and/or transceivers for one or more other wireless communication technologies (e.g., 4G).

The input device 116 includes hardware, firmware and/or software configured to enable a user to interact with (i.e., both provide inputs to) the client device 102. For example, the input device 116 may be a computer keyboard, a mouse, a tablet pen, etc. More than one input device 116 may be attached to the client device 102.

The display 118 includes hardware, firmware and/or software configured to enable a user to interact with (i.e., perceive outputs of) the client device 102. For example, the display 118 may be a computer monitor. In some embodiments, the input device 116 and the display 118 may be combined. For example, the display 118 may include a capacitive touchscreen with both display and manual input capabilities. Alternatively, or in addition, the display 118 may include a keyboard for accepting user inputs, and/or a microphone (with associated processing components) that provides voice control/input capabilities to the user.

The map access module 130 may correspond to a computer application executing in the memory 112 of the client device 102. The map access module 130 may include computer executable instructions for receiving/retrieving user input data from the user via the input device 116. The user input data may include such data an event (e.g., a key press, a mouse drag movement having coordinates, a pixel x, y coordinate, etc.). In general, the user input data may correspond to a user's creation, modification, and/or deletion of a topic map or a component thereof (e.g., a topic, an association, an occurrence, etc.). The map access module 130 may be coupled to a module of a remote computing device (e.g., the server 104) via a networked application programming interface (API). The API may be implemented using a secured networking protocol (e.g., HTTPS) and may facilitate the access of topic maps located on a remote computing device by the user of the map access module 130. The API may receive/retrieve data from the map access module 130 encoded in a common structured data format (e.g., XML, JSON, CSV, etc.), as plain text, in a proprietary data format, etc. For example, the map access module 130 may retrieve a topic map data object via the API, wherein the topic map data object is an electronic representation of a topic map, as defined and described herein. The map access module 130 may operate in concert with the front-end 132 to facilitate the display of topic maps.

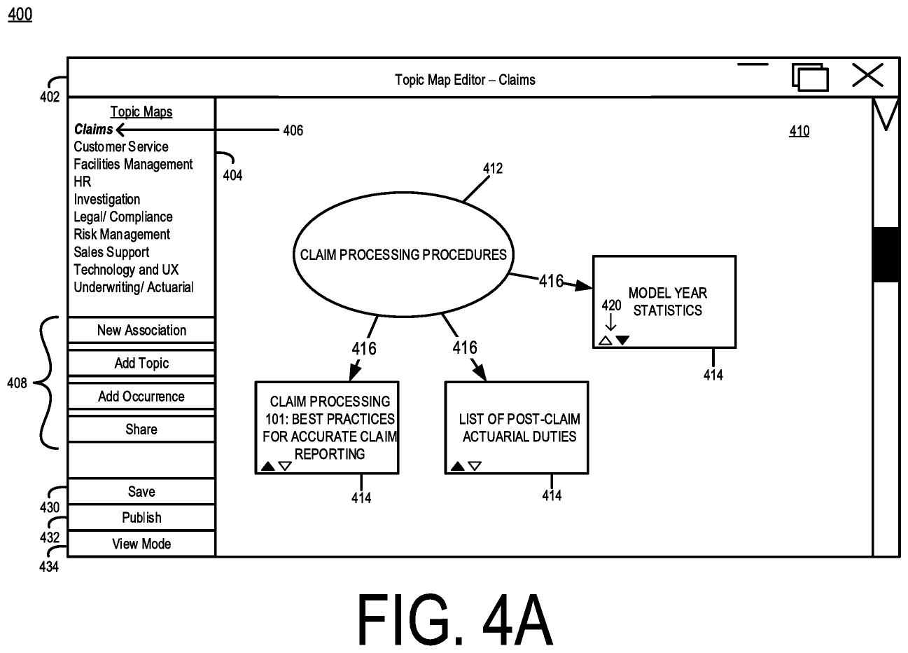

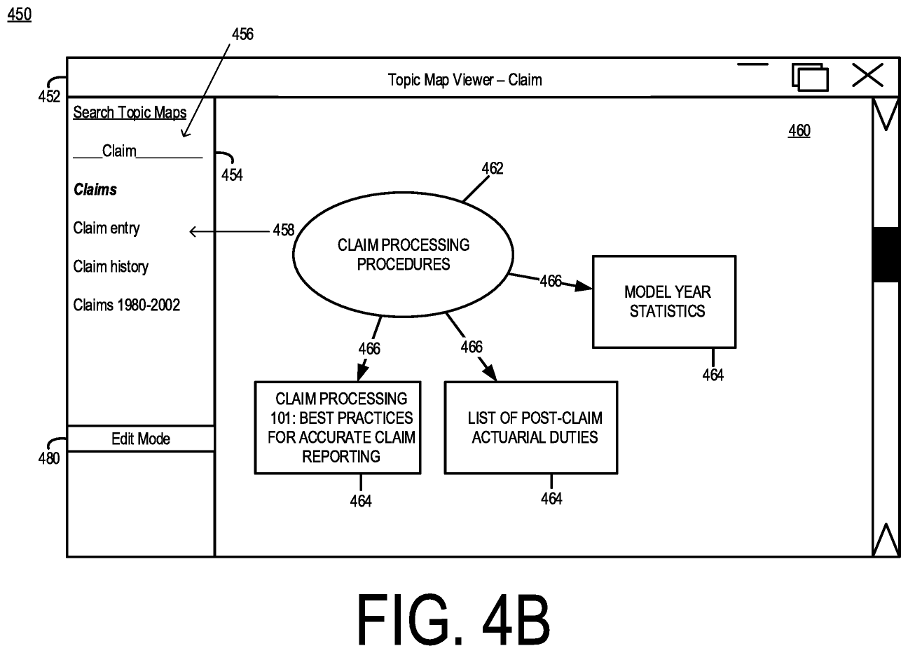

The map access module 130 may facilitate user operations related to topic maps, including without limitation, searching topic maps, creating/modifying topic maps, viewing/using topic maps, retrieving information resources, and opening linked topic maps. In some embodiments, the front-end 132 may include a map editor to facilitate map creation/editing and viewing, as depicted in FIG. 4A and FIG. 4B, respectively. The map access module 130 may include instructions for serializing and/or deserializing the map into the map data objects that are shared between two networked computing systems (e.g., the client device 102 and the topic map server device 104).

Specifically, the front-end 132 may be configured to perform graphical user interface display operations related to the display (e.g., formatting, screen painting, etc.) of one or more topic maps. The front-end 132 may include computer instructions for interpreting topic map data objects, and for converting topic map data objects to conventional graphical user interface elements (e.g., windows, controls such as inputs and buttons, stylistic elements, etc.). The front-end 132 may receive/retrieve the topic map data object from the map access 130. In some embodiments, the front-end 312 may include computer executable instructions for collecting the user input data. The front-end 132 may include instructions for submitting modified map data objects to the map access module 130. By using the front-end 132, a user may modify a local copy of a map, and the front-end 132 and map access module 130 may store the modifications in a remote copy of the map. By using the front-end 132, a user may select from a selection menu (e.g., an input field, a dropdown box, etc.) one or more other users with whom to share the topic map. The one or more other users may be notified when the user shares the topic map. The user may mark the topic map as private or public using the front-end 132. Once the user shares the topic map or marks the map public or private, the front-end 132 may generate one or more topic map data objects that include indications of the sharing and/or public/private attributes of the topic map. The front-end 132 may transmit the one or more topic map data objects via the network 106 to the server 104.

The front-end 132 may be implemented using Rich Internet Applications (RIA) that provide a native desktop feel to a web application. That is, the front-end 132 may provide a user with a web-based application (e.g., in a web browser, as a mobile computing application, etc.). In some embodiments, the front-end 132 may be provided as downloadable mobile computing application installed into an operating system of the client device 102. The RIA technologies may be used to aid topic map creation and editing. For example, once a topic map is created, users may use the front-end 132 to attach networked information grouped in a document occurrence to a topic node. Users may also access the front-end 132 to attach one or more topic maps to a topic node for expanding a complicated concept into more details. That way, it is possible to build a manageable topic map and connect the topic maps through occurrences and eventually build a virtual layer of information network that covers every networked information piece together in a domain (e.g., a personal interest area, data resources of an organization, the Internet, etc.). The front-end includes localization and mixed-language display capabilities. RIA include HTML5, CSS3, JavaScript, etc.

The front-end module 132 may operate in one or more map access modes (e.g., in an editing mode and a viewing mode). In some embodiments, the front-end module 132 includes instructions for operating an editing mode, including instructions for generating and displaying a topic map editor, that allows the user to create a new topic map and/or modify an existing topic map. In some embodiments, the user may be required to register before the user can access the editing mode. In some embodiments, the front-end module 132 includes instructions for operating a viewing mode, including instructions for displaying topic map search results, and for allowing the user to browse, navigate, and open elements within the topic map. For example, the viewing mode allows the user to browse, navigate, and open a list of occurrences, and to click on a URL within the list of occurrences to navigate to another resource (e.g., a remote resource, a different topic map in the viewing mode in the client device 102, etc).

The permissions module 134 may govern aspects of user privilege levels and document storage locations, by assigning users to different roles and allowing users to access different document storage locations. For example, user privilege levels may include an administrator level, registered user level and unregistered user level. A user may be assigned to one or more levels (e.g., registered user level and administrator level).

Document storage locations may include a public document space and a personal document space. Each user may access one or more document storage locations based on the user's respective user privileges. In general, a user with administrator privileges has full control of the system operation, including access to storage locations. A registered user can create and modify topic maps. An unregistered user can search and view the topic maps that are in a public document space, and/or create a personal topic map and store the personal topic map in the user's personal space. For example, when a registered user creates a new topic map or modifies an existing topic map, the user may store the new/modified topic map in a personal space, and/or publish the new/modified topic map in a public space. In some embodiments, all users are registered users (e.g., when the topic map system is used within an enterprise). The permissions module 134 may receive/retrieve user permission information from the topic maps database 108. Document storage locations may correspond to the database 108 and/or the remote document repository 180, in some embodiments.

A user's personal storage space is allocated to a registered user, and may include storage space in the topic map server device 104 and/or personal device storage in the client device 102. For example, the memory 112 of the client device 102 may include a personal storage space that an administrator assigns to a user. In some embodiments, computer-executable instructions are stored in the permissions module 134 that maintain a quota for the personal storage space. The personal storage space is under the full control of the user to whom it is assigned. The personal space in the topic map server device 104 may be accessed by the user to whom the storage space is assigned and the administrator. The user may access personal storage space using the graphical user interface programs described herein, via the client device 102 and/or the topic map server device 104. In some embodiments, the server 104 includes storage space accessible by all users (registered and unregistered). When a user publishes a topic map, computer-executable instructions in the front-end 132 may transfer the topic map from a personal storage space to a public storage space. For example, the topic map may be transferred from the memory 112 of the client device 102, to memory 152 of the topic map server device 104, or to the topic maps database 108.

The server 104 includes a processor 150 and a memory 152. The processor 150 may be a single processor (e.g., a central processing unit (CPU)), or may include a set of processors (e.g., a CPU and a graphics processing unit (GPU)). The memory 152 is a computer-readable, non-transitory storage unit or device, or collection of such units/devices, that may include persistent (e.g., hard disk) and/or non-persistent memory components. The memory 152 includes a mapping module 160, an attachment module 162, a crowdsource module 164, an event monitor module 166, a ranking module 168 and a search module 170. More or fewer modules may be included in the memory 152, in some embodiments and scenarios. For example, the memory 152 may include additional modules for processing user inputs, user account management, and managing editing. Each of the modules included in the memory 152 may access the topic maps database 108.

The server 104 further includes a network interface 154 which includes hardware, firmware and/or software configured to enable the server 104 to exchange electronic data with other devices on the network 106 (e.g., the client device 102) and to access other networked resources, such as the topic database 108. For example, network interface 154 may include a cellular communication transceiver, a Wifi transceiver, and/or transceivers for one or more other wireless communication technologies (e.g., 4g).

The mapping module 160 is generally configured to retrieve/receive electronic topic map data objects from the client device 102. The topic map data objects generally represent one or more topic maps local to the client device 102. For example, the received topic map data may represent changes to a topic map input by a user of the client 102. The mapping module 160 may store and/or retrieve such map data objects from the topic maps database 108 in response to the client device 102. For example, the mapping module 160 may receive an API call from the client device 102. The API call may include a parameter identifying one or more map identifiers (IDs). The one or more map IDs may include one or more root node IDs, corresponding to the map identifier of one or more topic map root nodes. In response to receiving the API call, the mapping module 160 may retrieve one or more map data objects from the topic maps database 108, wherein the ID of each map data objects corresponds to a respective one of the map IDs. The mapping module 160 may pass the retrieved map data objects to one or more modules for further processing.

In some embodiments, the API call may include user input data specifying a topic map structure and/or an operation or relationship with respect to the one or more map data objects. For example, the API call may include a nested list of map data objects, wherein the nesting of the list corresponds to relationships between elements in a topic map. The mapping module 160 may analyze the user input data to identify a change between a remote topic map and a local topic map, or to determine whether the received map data object does not correspond to a local topic map (i.e., a topic map stored in the topic map database 108). In that case, the mapping module 160 may create a topic map in the topic map database 108, and assign user data and/or the map data objects to the created topic map. The present techniques include automatic update mechanisms to detect changes in the networked information.

The attachment module 162 may analyze the topic map data objects the relationship between the topic map (e.g., the attachment module). In some cases the attachment module 162 may establish relationships between elements in a topic map. For example, the attachment module 162 may receive map data objects from the mapping module 160. The attachment module 162 may analyze the map data objects (e.g., the one or more map identifiers). The map data objects may correspond to, for example, one topic and two occurrences. The user may not have established any association between the user data objects. The attachment module 162 may create a default association between the map data objects, to keep the data elements complete and to allow the map data objects to be referenced by other modules (e.g., the crowdsource module 164). In the depicted embodiment, the attachment module 162 is communicatively coupled to a remote document repository 180. The remote document repository 180 stores remote resources. A user may retrieve a document in the remote document repository 180 by, for example, clicking on a link (e.g., a uniform resource locator (URL)).

The crowdsource module 164 is generally configured to permit one or more users to collaboratively create and edit topic maps. The crowdsource module 164 may include computer executable instructions for loading a topic map from the database 108 and providing multi-user editing capabilities. For example, the crowdsource module 164 may implement a lock or lock-free algorithm (e.g., a mutex) to synchronize access to the topic map. For example, the mutex prevents multiple users from making mutually exclusive edits. The crowdsource module 164 may function by receiving map data objects from the mapping module 160. The crowdsource module may determine an identity of the user corresponding to each map data object, and thereby prevent users from making non mutually-exclusive edits. The crowdsource module 164 may include instructions for establishing ownership of topic map data objects. For example, the crowdsource module 164 may assign a user ID to a topic map data object when the topic map data object is created by updating a database entry corresponding to the topic map data object. The crowdsource module 164 may store topic map data object history in the database (e.g., the topic map database 108). In this way, the edit history of the topic is available for display and analysis to other modules, such as the mapping module 160. Such historical information allows the mapping module 160 to, inter alia, retrieve and transmit last-edited information corresponding to a topic map. The crowdsource module 164 may analyze topic map data objects received by the mapping module 160 to determine when a topic map has been shared and/or made public/private. When the crowdsource module 164 detects an indication of sharing or publication, the crowdsource module 164 may update the topic maps database 108 accordingly. Other modules may analyze topic map data objects, in parallel with the crowdsource module 164 (e.g., the event monitor 166).

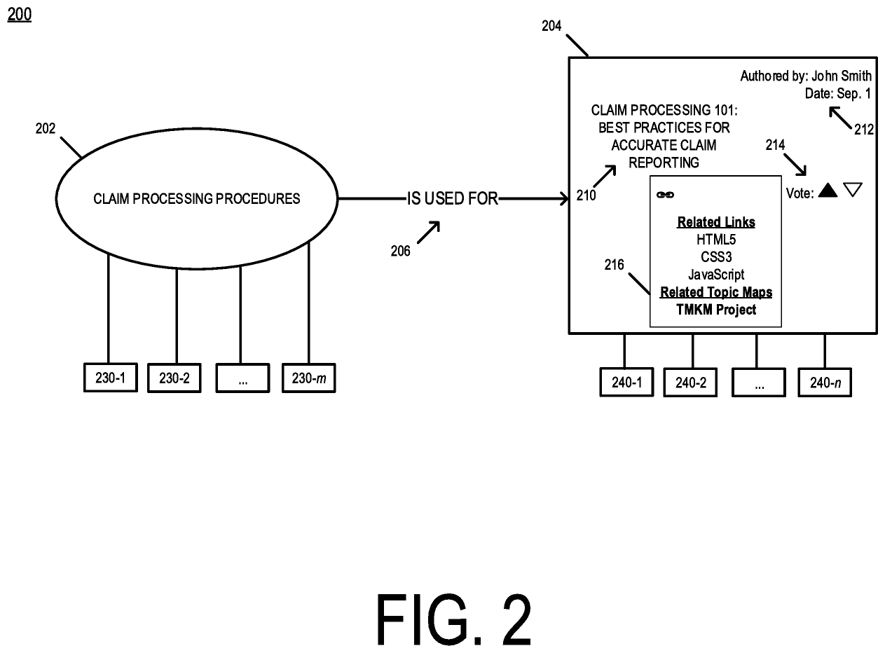

The event monitor 166 is generally configured to monitor one or more information source, wherein the one or more information source corresponds to one or more topic/occurrence (e.g., one or more map identifiers). For example, a topic such as the topic 202 of FIG. 2 may be entitled “claim entry procedures” and the topic may be included in one or more topic maps. Topic and occurrence may be represented by a unique map identifier in an electronic database such as the topic maps database 108. Information relating to the topic may be stored in a remote system other than the client 102, such as a wiki system (not depicted).

The event monitor 166 may monitor the topic such that when the topic changes, the event monitor 166 propagates the changes to each topic include in the one or more topic maps. The event monitor 166 may monitor remote topics by subscribing to notifications (e.g., via PubSub or another queueing mechanism) and/or by periodically polling remote information sources. For example, the event monitor 166 may mark a topic deleted in the remote system as such in the one or more topic maps, or may remove the topic from the one or more topic maps entirely. In some embodiments, the event monitor 166 may update the information included in the topic of the one more topic maps stored in the topic maps database 108, in accordance with the changes made to corresponding topics by a remote user. In some embodiments, the event monitor 166 may update associations between remote topics. For example, when a remote user associates a first remote topic and a second remote topic (e.g., two entries in the wiki system), the event monitor 166 creates an identical association between a first local topic and a second local topic, wherein the first remote topic corresponds to the first local topic and the second remote topic corresponds to the second local topic. In some embodiments, the event monitor 166 may create an association between the first local topic and the second local topic having a type identical to the type between the first remote topic and the second remote topic.

The ranking module 168 is generally configured to allow users to rank topics and/or occurrences within a topic map. The ranking module 168 may use multiple ranking categories and/or ranking algorithms to rank the topics and occurrences. For example, in an embodiment, the ranking module 178 may rank occurrences from highest to lowest, in accordance with the number of votes that each occurrence has received from users, wherein the votes are the positive and negative votes as discussed with respect to FIG. 2. The front-end 132 may collect votes, as discussed below. In another embodiment, the ranking module 168 may rank the topics and/or occurrences according to time of creation, or a category associated with each topic. The display of topics may be influenced by ranking. For example, topics having more votes may be displayed at the top of a graphical user interface. The display of occurrences may be influenced by ranking. For example, occurrences having higher ranks may be displayed in a fully expanded view, wherein occurrences having fewer votes may be displayed in a collapsed view. The expanded/collapsed view is one way to represent rankings, but other types of visual/graphical indications may be used to indicate the ranking of topics and occurrences (e.g., linear ordering, numbering, size proportional to votes, color, etc.).

The ranking module 168 may perform its ranking before the topic map is stored in the database, such that the topics and occurrences are stored in an order. In some embodiments, the ranking module 168 may store rank a topic map after retrieving the topic map from the topic maps database 108 but prior to transmitting the topic map to the client 102. In some embodiments, one or another ranking may be performed at the request of a user. For example, the user may request a ranking by vote, a category-based ranking, etc.

The ranking module 168 may use voting ranking, as noted above. In some embodiments, the ranking module 167 may use individual or combined ranking techniques using freshness, document type, data source, access limit, etc. For example, the ranking module 168 may rank a topic map higher because it is newer, includes a file attachment (e.g., a PDF) as opposed to mere plain text, is from an internal data source as opposed to an external data source/is from a peer reviewed journal as opposed to a blog, or is of unlimited availability as opposed to limited availability (e.g., a non-paywall sources vs. a paywall).

The search module 170 allows a user to search for a concept to find topic maps that match the search. For example, the user may enter a keyword such as “claim” in a search element of the front end 132 to find topic maps that include related concepts. The front-end 132 may include computer-executable instructions for transmitting the user's query to the search module 170, and for receiving and displaying a list of topic maps matching the user's search term. In conventional enterprise ECM systems, classification as a content categorization tool is not used. The search module 170 includes instructions for analyzing classification metadata of various topic maps, and generating a new topic map including only those topics wherein the classification metadata matches search terms. For example, an organization's root level topic map may include information from many different departments (e.g., finance, legal, executive, operations, facilities, etc.). A user may be interested in operations information only. The user may enter the term “operations” into a search filter of the front-end 132. The front-end 132 may transmit the search term via the network 106 to the search module 170 of the topic map server device 104. The search module 170 may then return a list of matching topic maps via the mapping node 160 to the map access module 130 of the client device 102, wherein only the topic maps having a classification matching the search term are displayed. Furthermore, the search module 170 uses concept searching, as opposed to keyword searching, in some embodiments. Concept searching allows the search module 170 to identify topic maps and/or occurrences that are semantic matches to the user's search terms, rather than relying on literal matching. For example, an operations user may enter a term such as “server uptime.” The search module 168 may analyze the conceptual/semantic meaning of the search term and return topic maps relating to service-level agreements (SLAs) and high availability tools generating and displaying knowledge management and discovery topic maps which define, but do not literally include, the concept of server uptime.

The computer-implemented methods discussed herein may include additional, fewer, or alternate actions, including those discussed elsewhere herein. The methods may be implemented via one or more local or remote processors, transceivers, servers, and/or sensors (such as processors, transceivers, servers, and/or sensors installed in mobile devices, or associated with smart infrastructure or remote servers), and/or via computer-executable instructions stored on non-transitory computer-readable media or medium.

In operation, an employee of a company accesses the client 102. The employee may use a mobile computing device (e.g., a smart phone, a tablet, a laptop, etc.) to access the client 102 remotely, or a direct input device such as the input device 116. The user may use a graphical user interface (GUI) to create a new topic map, add information to or delete information from an existing topic map, edit a topic map (e.g., add an association between two topics/occurrences), add/delete an occurrence, etc. The GUI may be rendered as an application, such as an internet browser or a in a device-specific user interface (e.g., as a native mobile application). The user may vote on a topic and/or an occurrence. The user may search a topic map using the GUI. As the user modifies the topic map displayed in the client 102, the client 102 may periodically and/or in response to changes caused by the user, transmit topic map data corresponding to the topic map via the network 106 to a remote computing device (e.g., the topic map server device 104). The remote computing device may store the transmitted data in an electronic database, such as the topic maps database 108.

A user may read a tutorial in creating topic maps, and create a map relating to a topic. The topic may be assigned by the user's employer, and the user may be selected to create the map based on the user's subject matter expertise. The user may create as many topics and occurrences within the topic map as the user desires, and once having created a topic and/or occurrence, may associate one or more documents to the topic using the front-end 132. For example the front-end 132 may include an “Attach a file” button that the user may select to add a file to the occurrence/topic node. Attached files are stored in the topic maps database 108, and are linked to an occurrence/topic by an identifier (e.g., a primary key).

Multiple instances of the client 102 and the server 104 may operate in parallel and asynchronously. For example, the user may modify a topic map via the front end 132 at the same time that the mapping module 160 receives modifications to the same topic map from other users. The mapping module 160 may update the remote copy of the topic map with the changes of the multiple users by using a mutex lock to maintain synchronization of the topic map.

### Exemplary Topic Map

FIG. 2 depicts an exemplary knowledge management and discovery topic map 200. The topic map 200 may be implemented using the graph theoretic concepts of nodes and edges. The topic map 200 includes a topic node 202, an occurrence node 204, and an association 206. The topic node 202 is a graphic topic node including a displayed topic name. A “topic” may be an ontological entity as defined by a public specification such as XTM, or a private ontology such as a corporate organizational/ontological chart. As shown in FIG. 2, the topic node 202 includes a topic name and is included in a visual topic map. In some cases, the organization may task an employee with creating topics by, for example, interviewing SMEs in various departments of the organization to collect organizational knowledge.

The occurrence node 204 may be an instance of the topic node 202, including information attached to the topic. The association 206 may be an edge between the topic node 202 and the occurrence node 204. The association 206 may be a directed or undirected edge. An association between two topics may be represented by relationship lines (e.g., graph edges) and labels. The topic node 202 may include one or more association 206. For example, a topic node 202 named “executives” may include multiple occurrence nodes 204, each representing a C-suite member of an organization. A “CEO” topic node 202 may include a single association 206 linking to a person occurrence 204. Therefore, the knowledge management and discovery topic map 200 may be used to represent linkages of information on a one-to-one, one-to-many, and/or many-to-many basis. Each topic 202 may include a list of related topic maps, related links, and/or related projects to which the topic 202 belongs. Such related information may be edited by a user accessing the front-end 132 of the client 102, for example.

The occurrence node 204 includes a description (i.e., title or name) 210, metadata 212 include the author's name and the creation data, and rating information 214. The rating information 214 may allow a user to cast a positive or negative vote indicating the user's view of the relevance of the occurrence 204 to the topic 202. The filled positive vote button reflects a user's belief that the occurrence 204 is relevant to the topic 202. When the user casts a vote, the rating information 214 is transmitted via a network (e.g., the network 106) to a remote computing device (e.g., the server 104) wherein the rating information 214 may be counted, to determine the relevance of the occurrence 204 to the topic 202 across all users of the system.

The occurrence node 204 further includes one or more occurrences 216. Each of the one or more occurrences 216 may include one or more attached URL (e.g., related links) and/or one or more URLs that link to related topic maps. Each URL may link to a respective networked resource (e.g., a remote resource) and/or related topic maps. An occurrence icon may be used to indicate when a topic node has attachment. When a user clicks the occurrence icon, on a visual topic map, an occurrence list may be displayed.

The topic node 202 may be associated with documents 230-1 through 230-m, wherein m is any positive integer. The occurrence node 204 may be associated with documents 240-1 through 240-n, wherein n is any positive integer. The documents 230 and documents 240 may be stored in an electronic database, such as topic maps database 108. The documents 230 and documents 240 may be of any suitable file types, such as PDFs, Word documents, image files, video files, etc. The documents 230 and documents 240 may be hyperlinks in some embodiments.

### Exemplary Edge Types

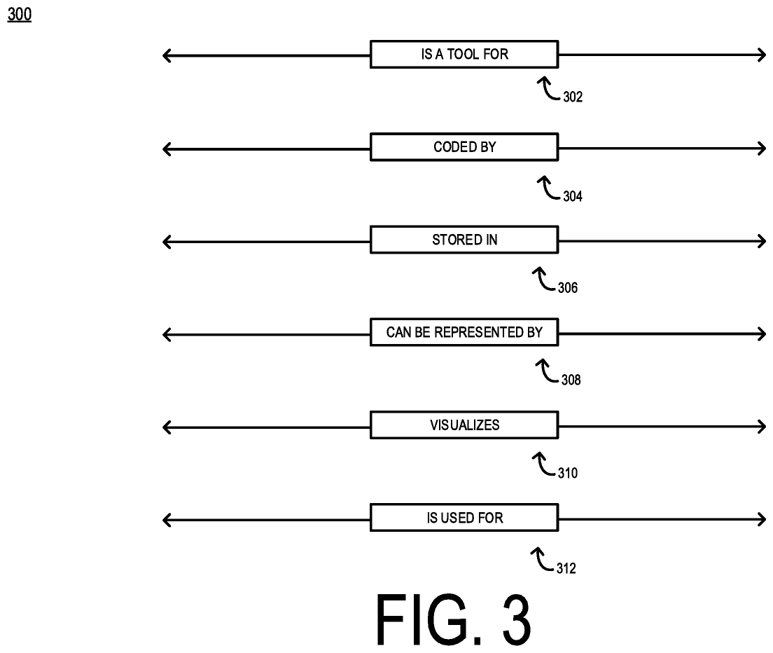

In some embodiments, the association 206 may have one or more edge type. FIG. 3 depicts a listing 300 of several exemplary edge types that may be used to represent relationships between entities represented by topic nodes, in some embodiments. For example, the listing 300 includes an edge type 302 representing that a first node is a tool for a second node. For example, a topic map node may be connected by a directed edge having the edge type 302 to a categorized content node. Such a connection would indicate that a topic map is a tool for categorizing content. The listing includes an edge type 304 representing that a first node is coded by a second node. For example, a classification system node may be connected by a directed edge having the edge type 304 to a topic map node. Such a connection would indicate that the classification system is coded by the topic map. The listing 300 includes an edge type 306 representing that a first node is stored in a second node. For example, a content node may be connected by a directed edge having the edge type 306 to a knowledge repository node, indicating that content is stored in the knowledge repository, wherein “content” and “knowledge repository” are both entities within a topic map (e.g., the topic map 200). The listing 300 includes additional edge types 308, 310, and 312 that respectively represent representation, visualization, and used-for node relationships. Specifically, edge type 308, edge type 310 and edge type 312 respectively represent that with respect to a first node and a second node, the first node is represented by the second node, that the first node visualizes the second node, and that the first node is used for the second node.

It will be appreciated that the edge types depicted in the listing 300 are merely examples, and that many more edge types are envisioned. Further, some embodiments include a mechanism that allow a user to add, edit and delete edge types. Users of the methods and systems herein may then themselves use the newly defined edge types to establish relationships between nodes, for example, using a visual application as depicted in FIG. 3.

### Exemplary Visual Application

As discussed above, conventional ECM methods and systems allow enterprise user to retrieve information based on keyword searching, wherein the information is displayed to the user in a flat list. The information is typically stored, conventionally, in multiple disaggregated information sources. Rather than creating content in a visual way, users create information using a variety of incompatible applications (e.g., a rich text document, a spreadsheet, a presentation, a code file, etc.). As noted, a KM professional finds such conventional information creation environments very difficult to manage, because data is spread out in vertical siloes, and conceptual links between data are not established. The visual application of the present techniques, which uses aspects discussed above, advantageously allows such conceptual linkages to be created, thereby improving the ability of the computer to quickly locate information that is relevant to users. The ability of users to vote on document quality/relevance improves the relevance of the information in the visual application. The visual application may display topics in accordance with the user-determined rankings, which allows the system to display the information that is most relevant to the user in an emphasized fashion, avoiding the need to display all information to the user, and thereby saving computational resources (e.g., CPU cycles and/or network bandwidth).

The present techniques allow users to edit and view topic maps according to the permissions of the user and/or the document storage location of the topic map. For example, when the user accesses a topic map stored in a public storage location, the topic may be initially displayed in a viewing mode. When the user is a registered user, or an administrator, the user may switch the viewing mode to an editing mode, wherein a topic map editor displays the topic map, allowing the user to modify the topic map and make changes to the topic map. Users may search for maps stored in the public space.

FIG. 4A depicts an example visual application 400 in an editing mode, according to an embodiment. The visual application 400 may correspond to the front-end 132 of FIG. 1, in some embodiments. In other embodiments, the visual application 400 may execute in a module of the memory 152 of the topic map server device 104. In embodiments wherein the client device 102 is a mobile computing device, the visual application 400 may be implemented as a mobile application (e.g., an Android APK, an iPhone application, etc.) available for download from an app store. The visual application 400 may include a window 402 including a menu 404, displaying a set of topic maps, from which the user may select an active topic map 406. The window 402 includes a set of user interface elements 408 allowing users to perform various actions in the topic map, including creating associations between elements (e.g., topics and occurrences), adding topics/occurrences, sharing the topic map, deleting a topic/occurrence, etc. The associations that may be created between elements may correspond to the edge types 302-312 of FIG. 3. The user may act directly on the elements of the visual application 400 using an input device (e.g., the input device 116 of FIG. 1) by, for example, a mouse click, a touch screen finger gesture, etc. The user may select the individual elements of the visual application 400 to perform actions. For example, the user may select a topic to rename the topic, or to add an association using the set of user interface elements 408.

The visual application 400 includes a workspace 410 wherein the elements of the topic map are displayed. The workspace 410 includes an example topic 412, associated with a set of example occurrences 414. The set of example occurrences are linked to the example topic 412 by a respective association 416. For simplicity, the associations are depicted as directed from the topic 412 to the set of example occurrences 414. Also, only one example topic 412 is depicted. However, those of skill in the art will appreciate that the workspace 410 may include any number of topics 412, which may be associated with other topics. The workspace 410 may include any number of occurrences 414 associated with the topics. The occurrences 414 may correspond to the occurrence 204 of FIG. 2, and include similar functionality. For example, in the depicted example, the user has voted positively for two of the occurrences, and negatively for one of the occurrences.

As noted, the visual application 400 may execute in the memory of the client 102, for example. The visual application 400 may include instructions for automatically generating the topic map data object corresponding to the topic map 412. The topic map data object may be generated periodically as the user accesses the visual application 400, or in response to the user changing an element of the workspace 410. In some embodiments, the window 402 includes a submit or save button that the user may activate to cause the map data object to be generated. The visual application 400 may include instructions for transmitting the map data object via the API to the server 104, as discussed with respect to FIG. 1. For example, the generated may data object may be transmitted to the topic map server device 104 any time that the map data object changes or is generated.

The visual application 400 may further include a save element 430 and/or a publish element 432. The save element 430 allows the user to save the topic map in a personal space. The publish element 432 causes the topic map 406 to be submitted to a publishing process and saved in a public space. The personal space and public space are may correspond to the topic maps database 108, in some embodiments. The user may also toggle between the editing mode depicted in FIG. 4A, to a view mode, as depicted in FIG. 4B, using the view mode toggle 434.

FIG. 4B depicts an example visual application 450 in a viewing mode, according to an embodiment. The visual application 450 may correspond to the visual application 400 of FIG. 4A. The visual application 450 includes a topic map window 452 including a menu 454, displaying a search box 456. The user may type a search query into the search box 456. Topic maps matching the user's search query are displayed beneath the search box 456 as search results 458.

The search box 456 enables the user to select a topic and/or occurrence filter, in some embodiments. Using the search box 456, the user is able to search for topic maps, topics, and/or occurrences using conceptual search, as discussed herein. For example, the search box 456 allows the user who types in the word “claim” to exclude all topics and occurrences that do not literally include the term “claim.” The search box 456 combined with concept search provides the user with the best of both worlds, and allows users to quickly and efficiently home in on the information that the user is seeking. In further embodiments, the visual application 400 may include tags (e.g., descriptors of each topic map). The user may click on a tag to show all maps including the tag.

The user may select one of the search results to display the selected topic map in a workspace 460. The workspace 460 includes a selected topic map 462 corresponding to the selection of the user. The workspace 460 may include one or more associations 466 linked, respectively, to one or more occurrences 464. When a user opens occurrence list, multiple ranking factors can be selected for creating different ranking views. The visual application 450 includes an edit mode element 480. When the user selects the edit mode element 480, the visual application 450 may display an editing application, such as the visual application 400 of FIG. 4A, allowing the user to edit the selected topic map.

### Exemplary Methods

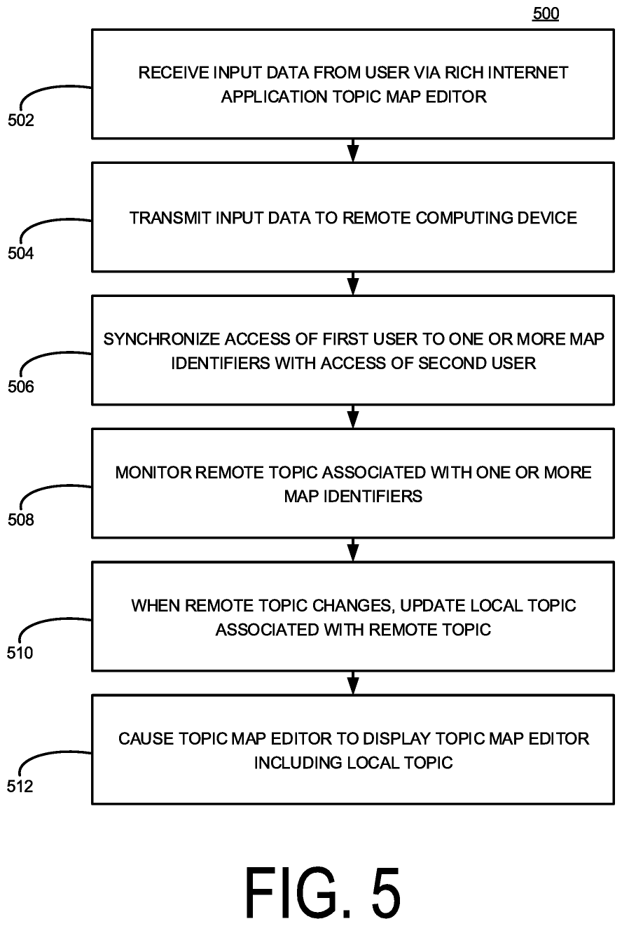

FIG. 5 depicts a block diagram of an exemplary method 500 for generating and displaying knowledge management and discovery topic maps, according to an embodiment. A user may use the present techniques to visually navigate a domain of knowledge, for knowledge management purposes, for research, and for creating presentations. The present techniques allow knowledge management professionals to establish a web of information, moving the information from individual disconnected siloes to a streamlined and efficient virtual topic map network. By allowing corporate users, in particular, to search across an entire organization's topic maps, the present techniques enable knowledge discovery (e.g., a user will find information that the user did not know was in existence and/or did not understand was relevant to the user's search).

Users may create maps that include keywords and tagging information also created/sourced by users. As the amount of information in the knowledge map increases over time, the searchability/findability of the information increases, because more relevant information that is concentrated in a single location is added over time. The present techniques advantageously improve computer functioning by removing the need for an information search engine to search through multiple sources, and organizing information in a structure that can be efficiently traversed by a search algorithm. For example, each topic map and the topics/occurrences therein may be represented using one or more tree data structures.

The method 500 includes receiving, via a processor, input data from a user via a rich internet application topic map editor, wherein the topic map includes at least one topic and at least one occurrence (block 502). For example, the rich internet application topic map editor may correspond to the visual application 400 of FIG. 4A and/or the visual application 450 of FIG. 4B. In some embodiments, the topic map editor may not be a rich internet application (e.g., the topic map editor may be a standalone desktop application). The topic map editor may execute in the client device 102 or the topic map server device 104. Although FIG. 1 depicts a client-server computing environment 100, in some embodiments a single client 102 or a single server 104 may implement the topic map editor 100. In such cases, synchronization of topic maps may be performed in a distributed fashion (e.g., users may respectively synchronize topic maps periodically, rather than in real-time). A distributed source control backend (e.g., Git) could be used to implement such distributed and asynchronous topic map editing.

The method 500 includes transmitting, via a computer network, the input data from the user corresponding to the topic map to a remote computing device, the input data including one or more map identifiers corresponding to the at least one topic and the at least one occurrence (block 504). For example, the front-end 132 may include instructions for periodically serializing and transmitting the topic map to an API endpoint (e.g., implemented by the mapping module 160) of the topic map server device 104 via the network 106.

The method 500 includes synchronizing an access of the first user to the one or more map identifiers with an access of a second user (block 506). For example, a first user may obtain a write lock in the topic maps database 108 when the user begins editing a topic map. When the user saves or closes the topic map, the lock is released and another user may obtain a write lock. Modifications made by users who do not have the write lock may be stored and automatically resolved. The database 108 may include an editing history that allows a registered user or administrator to revert a topic map to an earlier version.

The method 500 includes monitoring at least one remote topic associated with the one or more map identifiers (block 508). As noted, the monitoring may be effectuated using any suitable monitoring techniques, such as a message queue, PubSub, callback functions, cron tasks, etc. The method 500 includes when the remote topic changes, updating a local topic associated with the at least one remote topic (block 510). For example, if new PDF documents are added by a user to a remote topic, the method 500 may copy the PDF documents to a local copy of the topic. The method 500 may hash text using a fast hashing algorithm (e.g., md5sum) so that changes to text can be quickly detected by comparing existing hashes to new hashes.

The method 500 includes causing the topic map editor to display the rich internet application topic map editor including the local topic (block 512). Specifically, the topic map editor may include a set of computer executable instructions for painting a large canvas with portions of a topic map including topics and occurrences therein, depending on the screen size of the user. For example, the method may detect the window size of the window 402 of FIG. 4A and display a portion of the topic map that is 80% of the width of the monitor size. The method 500 may include horizontal and vertical scroll bars if the 80% width exceeds the width of a topic map canvas that includes the entire topic map.

In some cases, the method 500 includes receiving a new association between the at least one topic and the at least one occurrence. For example, a user of the client device 102 may access the front-end 132, and create an association (e.g., one of the edge types in the listing 300) linking two elements. The user may create the association by using an input device (e.g., the input device 116) to select one of the set of user interface elements 408 of FIG. 4A, for example, and by dragging the association between the two elements (e.g., a topic and occurrence, two topics, two occurrences, etc.). The user may, in some embodiments, right click on an element to display a context menu (not depicted) to access a New Association button.

The user may right click on an association to change the association direction (e.g., directed or undirected).

The method 500 may include receiving a search term from the user, such as “claim processing.” The method 500 may include identifying at least one concept included in the search term from the user, wherein the concept is an ontological term (e.g., CLAIM_PROCESSING). One or more search phrases may refer to the ontological term. A list of ontological terms and associated keywords may be constructed and stored in the topic maps database 108, in some embodiments. Fuzzy matching may be used in some embodiments to match keywords to ontological terms. The method 500 may include retrieving topics that match the concept include in the search term of the user, on the basis of the topic's content and/or metadata. In some cases, the search module 170 of FIG. 1 may create an index of concepts for each topic/occurrence that is created. The method 500 may display any topic map that includes one or more topic maps and/or occurrences whose respective index of concepts includes the search term of the user. The method 500 may include sorting the list of matching topic maps according to the number of matching concepts, such that the topic map having the most occurrences of the matching concepts are displayed at the top. Continuing the example, any topic map that includes the CLAIM_PROCESSING concept would be displayed in search results the method 500 displays to the user, with those maps having the highest number of references to CLAIM_PROCESSING at the top.

The method 500 may include serializing the one or more map identifiers and transmitting the serialized one or more map identifiers via an application programming interface. For example, a topic map displayed to a user may have a certain visual appearance. The topic map may be shown as a web of topics and occurrences, as depicted in the topic map 410 FIG. 4A. Yet the topic map 410 may be serialized to an object representation (e.g., a JSON object) for transmission across the network 106. Similarly, a topic map retrieved by the mapping module 160 may be transmitted in object form across the network 106 to the front-end 132, wherein the front-end may deserialize and display the topic map. An API (e.g., Asynchronous Javascript and XML (AJAX)) or a JavaScript framework, as discussed above, may be used for the conversion of objects into visual topic maps and vice versa.

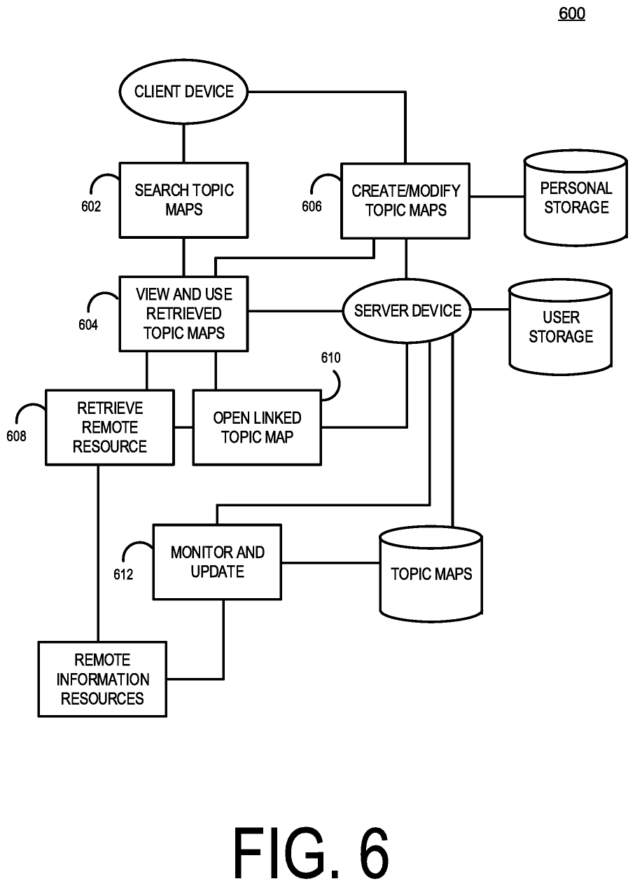

FIG. 6 depicts a block diagram of an exemplary method 600 for generating and displaying knowledge management and discovery topic maps, according to an embodiment. The method 600 includes a user of a client device searching for one or more topic maps (block 602). The method 600 includes searching topic maps (block 602). When a user searches the topic maps, the user's search query may be transmitted by a front end (e.g., the front-end module 132 of FIG. 1) to the search module 170 of the topic map server device 104. In some embodiments, the client device 102 may receive/retrieve the matching topic maps. The topic map server device 104 may transmit topic maps that match the search term to the client device 102, and the client device 102 may display the results (e.g., in the display 118). The user may select a topic map of interest. For example, the user may select the topic map depicted in FIG. 2. The user may then select from among the occurrences in the occurrence list. The user may toggle between edit and view modes, as depicted in FIG. 4A and FIG. 4B, respectively.

The method 600 may include the user viewing and using the retrieved topic maps, for example via the front-end 132 of FIG. 1 (block 604). A server device that may correspond to the topic map server device 104 may transmit a topic map to the client device the user accesses. For example, the user may select a topic map that the user finds via searching. The method 600 may include the user creating and modifying topic maps, for example via the front-end 132 of FIG. 1 (block 606). When the user creates a new topic map, the front-end may store the topic map in personal storage of the client device or the server device. When the user publishes the topic map, the front-end may store the topic map in a topic maps database, such as the topic maps database 108 of FIG. 1. The method 600 may include retrieving remote resources (block 608). For example, when the user selects an occurrence, the front-end may retrieve remote information resources. The remote information resources may include servers and/or repositories that hold networked information, and may be located within the environment 100 of FIG. 1, or outside the environment 100 (e.g., as a publicly-available resource). The method 600 may further include opening a linked topic map (610). The linked topic map may be one that a user has previously linked to the topic that the user is viewing.

The method 600 may further include monitoring remote resources and updating occurrences automatically (block 612). For example, the event monitor module 166 of the topic map server device 104 may monitor remote resources associated with the topic map and update the occurrence list when the any of the remote resources changes. It should be appreciated that the modules of the topic map server device 104 include functional programs for handling search queries, accepted user inputs, e.g. topic map data including user ranking votes, managing multi-thread editing activities, and user account and activities management, etc.

### Additional Considerations

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated.

These and other variations, modifications, additions, and improvements fall within the scope of the subject matter herein.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, the term “set” may include a collection of one or more elements.

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer implemented method for generating and displaying a knowledge management and discovery topic map, comprising:
receiving, via a processor of a server device, input data from a first user via a rich internet application topic map editor, wherein the topic map includes at least one topic and at least one occurrence;
receiving, via a computer network of the server device, the input data from the first user corresponding to the topic map, the input data including one or more map identifiers corresponding to the at least one topic and the at least one occurrence,
wherein the input data includes a serialized portion of the topic map;
synchronizing, by the processor of the server device, an access of the first user to the one or more map identifiers with an access of a second user, to prevent users from making mutually exclusive edits to the topic map stored in a single memory space,
wherein the synchronizing includes detecting a user identity seeking access to the topic map and assigning user ownership to the topic map, such that only an owner or authorized user can perform edits during a lock;
monitoring, by the processor of the server device, at least one remote topic associated with the one or more map identifiers;
when the remote topic changes, updating, by the processor of the server device, a local topic associated with the at least one remote topic; and
causing, by the processor of the server device, the topic map editor to display the rich internet application topic map editor including the local topic.

2. The method of claim 1, wherein receiving, via the processor, the input data from the user via the rich internet application topic map editor includes receiving a new association between the at least one topic and the at least one occurrence.

3. The method of claim 1, wherein receiving, via the processor, the input data from the user via the rich internet application topic map editor includes:
receiving a search term from the user via the rich internet application topic map editor,
identifying at least one concept included in the search term from the user, and
causing the topic map editor to display one or more topic maps that are associated with the identified concept.

4. The method of claim 1, wherein transmitting, via the computer network, the input data from the user corresponding to the topic map to the remote computing device, the input data including the one or more map identifiers corresponding to the at least one topic and the at least one occurrence includes serializing the one or more map identifiers and transmitting the serialized one or more map identifiers via an application programming interface.

5. The method of claim 1, wherein synchronizing the access of the first user to the one or more map identifiers with the access of the second user includes using one or both of (i) a locking algorithm, and (ii) a lock-free algorithm.

6. The method of claim 5, wherein the locking algorithm is a mutex lock.

7. The method of claim 1, wherein monitoring the at least one remote topic associated with the one or more map identifiers includes one or both of (i) subscribing to a message queue, and (ii) periodically polling a remote information resource.

8. The method of claim 1, further comprising:
receiving, via the processor, from a user via the rich internet application topic map editor, input data corresponding to a ranking of one or both of (i) the at least one topic, and (ii) the at least one occurrence.

9. A knowledge management and discovery topic map server device, comprising:
one or more processors, and
a memory including computer executable instructions that, when executed by the one or more processors, cause the server device to:
receive, via a processor of the server device, input data from a first user via a rich internet application topic map editor, wherein the topic map includes at least one topic and at least one occurrence;
receive, via a computer network of the server device, the input data from the first user corresponding to the topic map, the input data including one or more map identifiers corresponding to the at least one topic and the at least one occurrence,
wherein the input data includes a serialized portion of the topic map;
synchronize, by the processor of the server device, an access of the first user to the one or more map identifiers with an access of a second user, to prevent users from making mutually exclusive edits to the topic map stored in a single memory space,
wherein the synchronizing includes detecting a user identity seeking access to the topic map and assigning user ownership to the topic map, such that only an owner or authorized user can perform edits during a lock;
monitor, by the processor of the server device, at least one remote topic associated with the one or more map identifiers;
when the remote topic changes, update, by the processor of the server device, a local topic associated with the at least one remote topic; and
cause the topic map editor to display the rich internet application topic map editor including the local topic.

10. The server device of claim 9, the memory containing further instructions that, when executed by the one or more processors, cause the server device to:
receive a new association between the at least one topic and the at least one occurrence.

11. The server device of claim 9, the memory containing further instructions that, when executed by the one or more processors, cause the server device to:
receive a search term from the user via the rich internet application topic map editor,
identify at least one concept included in the search term from the user, and
cause the topic map editor to display the topic maps that are associated with the identified concept.

12. The server device of claim 9, the memory containing further instructions that, when executed by the one or more processors, cause the server device to:
store, in an electronic database, a default association between the at least one topic and the at least one occurrence.

13. The server device of claim 9, the memory containing further instructions that, when executed by the one or more processors, cause the server device to:
receive, via the processor, from a user via the rich internet application topic map editor, input data corresponding to a ranking of one or both of (i) the at least one topic, and (ii) the at least one occurrence.

14. The server device of claim 13, the memory containing further instructions that, when executed by the one or more processors, cause the server device to:
based on the ranking, order the one or both of (i) the at least one topic, and (ii) the at least one occurrence, and
cause the topic map editor to display the ordered one or both of the at least one topic and the at least one occurrence.

15. A non-transitory computer readable medium containing program instructions that when executed, cause a server device to:
receive, via a processor of the server device, input data from a first user via a rich internet application topic map editor, wherein the topic map includes at least one topic and at least one occurrence;
receive, via a computer network of the server device, the input data from the first user corresponding to the topic map, the input data including one or more map identifiers corresponding to the at least one topic and the at least one occurrence,
wherein the input data includes a serialized portion of the topic map;
synchronize, by the processor of the server device, an access of the first user to the one or more map identifiers with an access of a second user, to prevent users from making mutually exclusive edits to the topic map stored in a single memory space,
wherein the synchronizing includes detecting a user identity seeking access to the topic map and assigning user ownership to the topic map, such that only an owner or authorized user can perform edits during a lock;
monitor, by the processor of the server device, at least one remote topic associated with the one or more map identifiers;
when the remote topic changes, update, by the processor of the server device, a local topic associated with the at least one remote topic; and
cause, by the processor of the server device, the topic map editor to display the rich internet application topic map editor including the local topic.

16. The non-transitory computer readable medium of claim 15, including further program instructions that when executed, cause the server device to:
receive a new association between the at least one topic and the at least one occurrence.

17. The non-transitory computer readable medium of claim 15, including further program instructions that when executed, cause the server device to:
receive a search term from the user via the rich internet application topic map editor,
identify at least one concept included in the search term from the user, and
cause the topic map editor to display the topic maps that are associated with the identified concept.

18. The non-transitory computer readable medium of claim 15, including further program instructions that when executed, cause the server device to:
store, in an electronic database, a default association between the at least one topic and the at least one occurrence.

19. The non-transitory computer readable medium of claim 15, including further program instructions that when executed, cause the server device to:
receive, via the processor, from a user via the rich internet application topic map editor, input data corresponding to a ranking of one or both of (i) the at least one topic, and (ii) the at least one occurrence.

20. The non-transitory computer readable medium of claim 19, including further program instructions that when executed, cause the server device to:
based on the ranking, order the one or both of (i) the at least one topic, and (ii) the at least one occurrence, and
cause the topic map editor to display the ordered one or both of the at least one topic and the at least one occurrence.
